(19) United States
(12) Patent Application Publication
(10) Pub. No.: US 2011/0137060 A1
(43) Pub. Date: Jun. 9, 2011

(54) PREPARATION OF ANSA METALLOCENE COMPOUNDS

(75) Inventors: Reynald Chevalier, Frankfurt (DE); Ouardia Ghersella, Frankfurt (DE)

(73) Assignee: Basell Polyolefin GmbH, Wesseling (DE)

(21) Appl. No.: 12/737,750

(22) PCT Filed: Aug. 19, 2009
(86) PCT No.: PCT/EP2009/005990

§ 371 Date: Feb. 23, 2011

Related U.S. Application Data
(60) Provisional application No. 61/191,104, filed on Sep. 5, 2008.

(30) Foreign Application Priority Data
Aug. 25, 2008 (EP) 08014959.4

(51) Int. Cl. C07F 17/00

(52) U.S. Cl. 556/53

(57) ABSTRACT

The present invention refers to a process for overcoming the problem of formation of oligomeric-polymeric complexes during preparation of cyclopentadienyl metallocenes comprising ligands bridged by at least three carbon atoms. According to the invention a process is presented comprising the steps of deprotonating a biscyclopentadienyl ligand bridged by a chain having a backbone of at least three carbon atoms by a base and reacting the deprotonated ligand with at least one alkali or alkaline earth metal alkylating agent and a salt of a transition metal belonging to group 3, 4, 5, 6 or to the lanthanide or actinide groups of the Periodic Table of the Elements.

This application is the U.S. national phase of International Application PCT/EP2009/005990, filed Aug. 19, 2009, claiming priority to European Application 08014959.4 filed Aug. 25, 2008 and the benefit under 35 U.S.C. 119(e) of U.S. Provisional Application No. 61/191,104, filed Sep. 5, 2008; the disclosures of International Application PCT/EP2009/005990, European Application 08014959.4 and U.S. Provisional Application No. 61/191,104, each as filed, are incorporated herein by reference.

### FIELD OF THE INVENTION

The present invention relates to a method of preparation of ansa-metallocene compounds bridged by a chain having a backbone of at least three carbon atoms. Certain of these ansa cyclopentadienyl compounds are useful as catalyst components with aluminoxane or ionic activator systems for olefin polymerization.

### BACKGROUND OF THE INVENTION

In the preparation of cyclopentadienyl metallocenes comprising ligands bridged by at least three carbon atoms, the transmetallation step between a halogenated ZrCl₄ and the dideprotonated ligand leads mainly to oligomeric-polymeric complexes. This means that in addition to the intramolecular reaction an intermolecular reaction takes place. The resulting mixtures are barely extractable and lead to low yields.

In European Journal of Inorganic Chemistry, 2001, 2097-2106, Erker and coll. describe the synthesis of two C₉- and C₁₂-bridged metallocenes using high dilution techniques. Yields are fairly low, respectively 7% and 18%, because soxhlet techniques have to be used to remove all oligomeric metallocenes.

An analogous preparation of n-propyl bisindenyl zirconium dichloride using the high dilution techniques, with a 10 folds more dilution in comparison to the classical route leads to a yield of pure rac metallocene of 18%, twice the yield of the classical route. This result, however, still is too low and is not applicable to production because of the low productivity and thus high production costs.

In Organometallics, 1991, 10, 5, 1501-5, Buchwald and coll. describe the improvement of the synthesis of a C₂-bridged metallocene using a three reactors technique. The two reagents must be added in the same rate and over 5-7 h, otherwise yield drops dramatically. In the following scheme the reaction is shown,

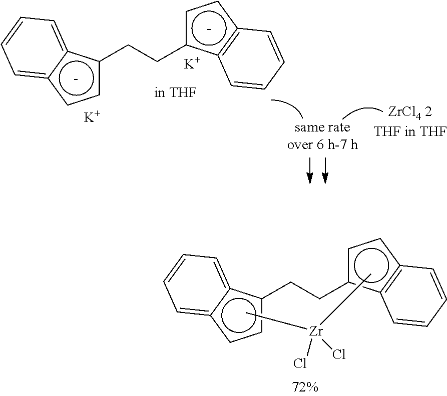

Following these requirements, yield of isolated racemic metallocenes is 72% which is quite high. The process apparently is very time consuming.

In US 2005/01599300 A1, a similar strategy is applied to synthesize n-propylene bis(indenyl) zirconium dichloride. Yield of racemic metallocene is close to 34% which is also very good.

In view of the drawbacks of the methods of the state of the art it was an object of the present invention to provide a new and less time consuming process for selectively preparing ansa-bisindenyl metallocenes bridged by a chain having a backbone of at least three carbon atoms and to reduce side reaction as far as possible.

### SUMMARY OF THE INVENTION

Surprisingly it had been found that another synthesis, which directly leads to metallocene dialkyl does not lead to polymeric metallocene complexes but selectively to monomeric complexes.

The principle of syntheses which lead to metallocene dialkyl instead of metallocene dichloride is described in WO99/36427 A1, WO00/75147 A1, and WO00/75151 A1.

According to the present invention a process for the preparation of ansa cyclopentadienyl metallocenes comprising bridges of a chain having a backbone of at least three carbon atom wherein a biscyclopentadienyl ligand bridged by a chain having a backbone of at least three carbon atoms is deprotonated by a base and reacted with at least one alkali or alkaline earth metal alkylating agent and a salt of a transition metal belonging to group 3, 4, 5, 6 or to the lanthanide or actinide groups of the Periodic Table of the Elements. Surprisingly, no polymeric complexes are prepared by the above synthesis. The transmetallation step leads to rac/meso mixtures of monomeric metallocenes. After workup and isolation steps, carbon chain bridged metallocenes have been isolated in yields from 31% to 54%. It is noteworthy that no high dilution is needed which is a crucial point regarding production efficiency and costs.

### DETAILED DESCRIPTION OF THE INVENTION

The cyclopentadienyl ligand may be substituted by C₁-C₂₀ alkyl groups, C₃-C₂₀ cycloalkyl groups, C₂-C₂₀ alkenyl groups, C₆-C₂₀ aryl groups, C₇-C₂₀ alkylaryl groups, optionally containing silicon or germanium atoms, wherein two adjacent substituents also may form a aromatic or aliphatic ring or ring system comprising from 5 to 44 carbon atoms. It preferably is selected from cyclopentadienyl, indenyl, tetrahydroindenyl, or indacenyl. Especially preferred are indenyl and indacenyl ligands.

Preferably the ligands π-bonded to said metal M comprise ring systems selected from indenyl and indacenyl which may be substituted by C₁-C₈ alkyl groups, C₃-C₁₄ cycloalkyl groups, C₂-C₈ alkenyl groups, C₆-C₁₄ aryl groups and C₇-C₁₄ alkylaryl groups. Especially preferred ligands are unsubstituted indenyl, unsubstituted indacenyl, 2-methylindacenyl.

The ligand comprises a bridge which is a chain having a backbone of at least three carbon atoms. Preferably, the bridge is a chain having a backbone of 3 to 20 carbon atoms.

The transition metal is preferably Ti, Zr or Hf, especially preferred Zr. The anions of the transition metal salt are preferably the same and are selected from the group consisting of —Cl, —Br, —OMe, —OEt, —OPr, —OBu and —OBz. Said salt of the transition metal is preferably selected from the group consisting of TiCl₄, ZrCl₄, HfCl₄, Ti(OEt)₄, Ti(OPr)₄, Ti(OBz)₄, Zr(OEt)₄, Zr(OPr)₄, Zr(OBz)₄, Zr(OEt)₃Cl, Hf(OEt)₄, Hf(OPr)₄ and Hf(OBz)₄. The transition metal halide may be used in the form of an ether complex, e.g. TiCl₄(THF)₂, ZrCl₄(THF)₂, HfCl₄(THF)₂ which can be prepared in a hydrocarbon solvent and used directly in the reaction with the ligand salt without separation from the solvent medium (THF=tetrahydrofurane).

The process of the present invention involves the deprotonation of a neutral ligand precursor with a suitable base. Nonrestrictive examples of suitable bases are alkyl lithium reagents such as n-butyllithium, sec-butyllithium, tert-butyllithium, methyllithium, organomagnesium compounds such as dibutylmagnesium, butyloctylmagnesium, Grignard compounds, alkali metal, such as sodium, potassium, alkali metal hydrides such as lithium hydride, sodium hydride, potassium hydride or alkali metal amides such as lithium amide, sodium amide, potassium amide, sodium hexamethyl disilazide, potassium hexamethyldisilazide, lithium hexamethylsilazide, lithium diisopropylamide, lithium diethylamide. Especially preferred is n-butyllithium.

The alkylating agents include any of the known alkyl-group containing organometallic compounds and preferably are selected from alkaline or alkaline earth metal compounds or Grignard reagents.

Alkaline or alkaline earth metal compounds represented by LjB and Grignard reagents represented by LMgL′ are alkylating agents, wherein L is preferably a C₁-C₇ alkyl group, a C₆-C₁₄ aryl group, or a C₇-C₁₄ arylalkyl group, optionally substituted with Si or Ge, and more preferably L is selected from the group consisting of methyl, ethyl, n-butyl, sec-butyl, tert-butyl, neo-pentyl, phenyl, benzyl and —CH₂Si(CH₃)₃; even more preferably, L is methyl. In the compound Lj B, B is an alkaline or alkaline-earth metal, and preferably Li or Mg; j can be 1 or 2. In compound LMgL′ Mg is magnesium and L and L′ have the meanings reported above; wherein L′ is preferably Cl or Br.

Examples for these alkylating agents include methyl lithium, methylmagnesium chloride, methylmagnesium bromide, methylmagnesium iodide. Further examples are dimethyl zinc and trimethyl aluminium. According to an especially preferred embodiment of the process of the invention said alkylating agent is methyllithium.

The process of the invention preferably is carried out in an aprotic solvent, either polar or apolar; said aprotic solvent is preferably an aromatic or aliphatic hydrocarbon or an ether, and more preferably it is selected from the group consisting of tetrahydrofurane, benzene, toluene, pentane, hexane, heptane, cyclohexane, diethylether or mixtures thereof. Especially preferred is tetrahydrofurane (THF).

According to another embodiment of the process of the invention, in step (1), said cyclopentadienyl ligand is previously dissolved in an aprotic solvent and the deprotonating base is added to the resulting solution. This addition is preferably carried out at a temperature ranging from −100° C. and +80° C., and more preferably from −10° C. and +30° C. The deprotonating base is preferably added in the form of a solution in one of the above mentioned aprotic solvents, and preferably by slowly dropping.

The thus obtained reaction mixture is preferably allowed to react, under stiffing, for a period ranging from 1 hour to 6 hours, and more preferably from 2 hours to 3 hours, at a temperature from −10° C. to +80° C., and more preferably at room temperature.

The alkylating agent and the transition metal salt are preferably added at a temperature from −10° C. to +80° C., and more preferably at room temperature.

The reaction mixture is then allowed to react for a period ranging from 1 to 6 hours at a temperature from −10° C. to +80° C., and more preferably at room temperature.

In a preferred embodiment the process according to the present invention comprises the following steps:

(1) deprotonating an alkylene biscyclopentadienyl ligand wherein the ligands are bridged by a chain having a backbone of at least three carbon atoms with 2 molar equivalents of a deprotonating base,
(2) adding 2 molar equivalents of an alkylating agent; and
(3) adding one molar equivalent of a salt of a transition metal belonging to group 4 of the Periodic Table of the Elements.
The metallocene compounds can be finally isolated from the reaction mixture obtained in step (3) and optionally purified according to standard procedures.

An example of the transition metal complex is represented by formula I

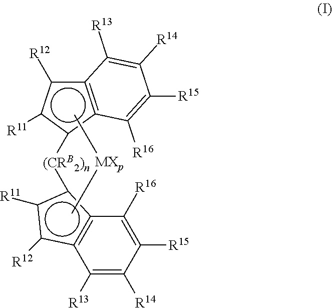

wherein
M is a transition metal belonging to group 3, 4, 5, 6 or to the lanthanide or actinide groups of the Periodic Table of the Elements (IUPAC version);
R^{B} may be the same or different and are selected from the group consisting of hydrogen, halogen, trimethylsilyl, C₁-C₁₀-alkyl, C₁-C₁₀-fluoroalkyl, C₆-C₁₀ fluoroaryl, C₆-C₁₀ aryl, C₁-C₁₀ alkoxy, C₇-C₁₅ alkylaryloxy, C₂-C₁₀ alkenyl, C₇-C₄₀ arylalkyl, C₈-C₄₀ arylalkenyl and C₇-C₄₀ alkylaryl,
n is an integer between 3 and 20;
X are the same or different and are selected from the group consisting of linear or branched, saturated or unsaturated C₁-C₂₀ alkyl, C₃-C₂₀ cycloalkyl, C₆-C₂₀ aryl, C₇-C₂₀ alkylaryl and C₇-C₂₀ arylalkyl groups, optionally containing one or more Si or Ge atoms
p is an integer from 1 to 3 being equal to the oxidation state of the metal M minus 2;
R¹¹ and R¹² are identical or different and are each hydrogen or a C₁-C₂₀ group, preferably C₁-C₁₈-alkyl such as methyl, ethyl, n-propyl, n-butyl, n-pentyl, n-hexyl, n-heptyl, n-octyl, n-nonyl, n-decyl, cyclopentyl or cyclohexyl, isopropyl, isobutyl, isopentyl, isohexyl, tert-butyl, C₂-C₁₀-alkenyl, C₃-C₁₅-alkylalkenyl, C₆-C₁₈-aryl, C₄-C₁₈-heteroaryl, C₇-C₂₀-arylalkyl, C₇-C₂₀-alkylaryl, fluorinated C₁-C₁₂-alkyl, fluorinated C₆-C₁₈-aryl, fluorinated C₇-C₂₀-arylalkyl or fluorinated C₇-C₂₀-alkylaryl, where R¹¹ together with R¹² may also form a monocyclic or polycyclic ring system, and
R¹³, R¹⁴, R¹⁵ and R¹⁶ are identical or different and are each a hydrogen atom or a C₁-C₂₀ group, e.g. methyl, ethyl, n-propyl, n-butyl, n-pentyl, n-hexyl, n-heptyl, n-octyl, n-nonyl, n-decyl, cyclopentyl or cyclohexyl, isopropyl, isobutyl, isopentyl, isohexyl, tert-butyl, C₂-C₁₀-alkenyl, C₃-C₁₅-alkylalkenyl, C₆-C₁₈-aryl, C₄-C₁₈-heteroaryl, C₇-C₂₀-arylalkyl, C₇-C₂₀-alkylaryl, fluorinated C₁-C₁₂-alkyl, fluorinated C₆-C₁₈-aryl, fluorinated C₇-C₂₀-arylalkyl or fluorinated C₇-C₂₀-alkylaryl and two adjacent radicals R¹³ and R¹⁴ or R¹⁴ and R¹⁵ or R¹⁵ and R¹⁶ may form together with the two carbon atoms of the indenyl ring a monocyclic or bi- or polycyclic ring system, e.g. aromatic or aliphatic cyclopentyl, cyclohexyl, cycloheptyl, cyclooctyl, cyclononyl, cyclodecyl.

The substituents X are the same or different and are selected from the group consisting of linear or branched, saturated or unsaturated C₁-C₂₀ alkyl, C₃-C₂₀ cycloalkyl, C₆-C₂₀ aryl, C₇-C₂₀ alkylaryl and C₇-C₂₀ arylalkyl groups, optionally containing one or more Si or Ge atoms. The substituents X are preferably the same and are selected from the group consisting of C₁-C₇ alkyl groups, C₆-C₁₄ aryl groups and C₇-C₁₄ arylalkyl groups, optionally containing one or more Si or Ge atoms; more preferably, the substituents X are selected from the group consisting of methyl, ethyl, n-butyl, sec-butyl, tert-butyl, neo-pentyl, phenyl, benzyl and —CH₂ Si(CH₃)₃. According to a favourite embodiment of the invention, X is methyl.

The preparation process is particularly interesting for a class of metallocenes of the formula (I), wherein the transition metal M is zirconium, the X substituents are methyl groups, the substituents R^{B} are hydrogen atoms and n is 3. Most preferably the substituents R¹², R¹³ and R¹⁶ are the same and hydrogen, R¹¹ is hydrogen or a C₁-C₈ alkyl and R¹⁴ and R¹⁵ are the same or different and selected from hydrogen and C₁-C₈ alkyl or R¹⁴ and R¹⁵ together with the two carbon atoms of the indenyl form an aromatic or aliphatic C₅ or C₆ ring. Non limiting examples are: 1,3-propandiyl bisindenyl dimethyl zirconium, 1,3-propandiylbis (indacenyl) dimethyl zirconium, 1,3-propandiylbis (2-methyl indacenyl) dimethyl zirconium

The ligand preferably is of formula (II):

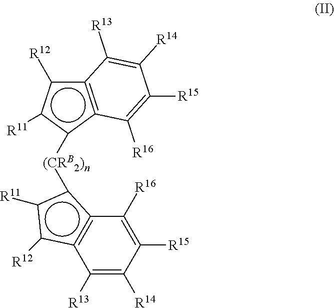

wherein the variables have the same meaning as in formula (I).

The above metallocenes form suitable polymerization catalytic systems as disclosed in WO 00/31088 A1.

The following examples are given for illustrative and not limitative purposes.

### EXAMPLES

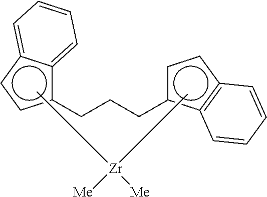

### propylene bis(indenyl) dimethyl zirconium

### Example 1 (Comparative)

### Synthesis of propylene bis(indenyl) zirconium dichloride via classical synthesis

1 g (3.67 mmol) of 1,3-bis(indenyl)propane was dissolved in 15 ml of toluene and 0.77 ml of THF (2.5 eq). n-BuLi (2.93 ml, 2 eq, 2.5 M in hexane) was added dropwise at 4° C. At the end of the addition, a gum appeared on the wall of the glass reactor. This gum was stirred 2 h at 25° C. Then a suspension of ZrCl₄.2THF (prepared in situ from ZrCl₄ (0.86 g, 1 eq) and THF (0.77 ml, 2.5 eq/Zr) in toluene (15 ml) was added at 25° C. The resulting brown-orange suspension was stirred overnight ¹H-NMR of the suspension was measured in CD₂Cl₂. The ¹H-NMR shows a high ratio of polymeric metallocene complexes.

The suspension was filtered and salts washed with 2×20 ml of toluene. Then the toluene solution was concentrated to dryness. ¹H-NMR of yellow salt didn't show any monomeric metallocene whereas the toluene solution shows minor amounts of monomeric metallocene. Then the toluene solution was concentrated to dryness. Acetone (10 ml) was added. A yellow suspension appeared. After 30 minutes of stirring, it was filtered and washed with 2×2 ml of acetone. After drying, 190 mg (11%) of a yellow powder was isolated.

According to ¹H-NMR spectrum only the racemic isomer is isolated.

¹H-NMR (CD₂Cl₂): 7.62-7.60 (m, 4H, arom.), 7.33-7.30 (m, 2H, arom.), 7.19-7.16 (m, 2H, arom.), 6.21 (d, 2H, J=2.7 Hz, Cp), 6.04 (brd, 2H, J=2.7 Hz, Cp), 3.14-3.09 (m, 2H, propyl), 2.95-2.90 (m, 2H, propyl), 2.42-2.37 (m, 2H, propyl).

### Example 2 (Comparative)

### Synthesis of propylene bis(indenyl) zirconium dichloride via the classical synthesis and in high dilution (*10)

The preparation (1 g of ligand) was carried out analogously to comparative example 1 except for the volume of toluene (10 folds). In this case, after the addition of nBuLi, a suspension appeared instead of a gum. ¹H-NMR of the transmetallation measured in CD₂Cl₂ showed monomeric metallocenes in a rac/meso ratio of 3 along with polymeric metallocenes.

The suspension was filtered and salts washed with 2×20 ml of toluene. Then the toluene solution was concentrated to dryness. Acetone (10 ml) was added. A yellow suspension appeared. After 30 minutes of stirring, it was filtered and washed with 2×2 ml of acetone. After drying, 285 mg (18%) of a yellow powder was isolated. 1H-NMR showed that it is only the racemic isomer.

### Example 3 (Invention)

### Synthesis of propylene bis(indenyl) dimethyl zirconium via direct synthesis in THF

5.57 g (20.45 mmol) of 1,3-bis(indenyl)propane was dissolved in 84 ml of THF. nBuLi (16.35 ml, 2 eq, 2.5 M in hexane) was added dropwise at 4° C. The brown solution was stirred 2 h at 25° C. Then MeLi (25.56 mL, 2 eq, 1.6M in Et₂O) was added at 25° C. and the solution was stirred for 30 minutes. Then a in situ prepared suspension ZrCl₄.2THF (1 eq) in a mixture of toluene/THF (16 ml/58 ml) was added at 25° C. The resulting brown light suspension was stirred overnight. ¹H-NMR of the transmetallation measured showed only monomeric metallocenes in a rac/meso ratio of 3.

75% of solvents were removed in vacuo. Then toluene (120 ml) was slowly added and the suspension stirred 2 h at 25° C. This suspension was filtered. The mother liquor was concentrated (85%) and a suspension appeared. It was filtered and washed with toluene (2×3 ml). 2.75 g (31%) of the racemic metallocenes was isolated as a white-grey powder. 1H-NMR spectrum shows the isolated racemic metallocene.

¹H-NMR (CD₂Cl₂): 7.56-7.54 (d, 2H, J=6.7 Hz, arom.), 7.39-7.37 (dd, 2H, J=6.7 Hz and J=0.6 Hz, arom.), 7.12-7.04 (m, 4H, arom.), 6.15 (d, 2H, J=2.7 Hz, Cp), 5.77 (d, 2H, J=2.7 Hz, Cp), 2.90-2.87 (m, 2H, propyl), 2.73-2.70 (m, 2H, propyl), 2.12-2.07 (m, 2H, propyl), −1.13 (s, 6H, Me-Zr).

### Example 4 (Invention)

### Synthesis of propylene bis(indenyl) dimethyl zirconium via the direct synthesis in toluene

The preparation was carried out analogously as described in example 3 except for the solvent. In this case toluene/THF (2 eq) was used in the deprotonation step and also in the formation of ZrCl₄.2THF adduct. According to ¹H-NMR of the transmetallation step, only monomeric metallocene in a rac/meso ratio of 2 was measured. This metallocene was not isolated.

### Example 5 (Invention)

### Synthesis of 1,3-propandiylbis (indacenyl) dimethyl zirconium via the direct synthesis in THF

The preparation was carried out analogously as described in example 3 with the exception that 1,3-bis(indacenyl)propane was used instead of 1,3-bis(indenyl)propane. ¹H-NMR spectra of the reaction mixture after the transmetallation step shows only monomeric structures and a rac/meso ratio of 1. A mixture with a rac/meso ratio of 1 was isolated with a 54% yield.

### Example 6 (Comparative)

### Synthesis of 1,3-propandiylbis (indacenyl) zirconium dichloride via classical synthesis

The preparation was carried out analogously as described in Example 1 (Comparative) with the exception that 1,3-bis(indacenyl)propane was used instead of 1,3-bis(indenyl)propane. According to 1H-NMR, only oligomeric complexes and intractable material has been formed.

### Example 7 (Invention)

### Synthesis of 1,3-propandiylbis (2-methyl indacenyl) dimethyl zirconium via the direct synthesis in THF

The preparation was carried out analogously as described in example 3 with the exception that 1,3-bis(2-methyl indacenyl)propane was used instead of 1,3-bis(indenyl)propane. 1H-NMR spectra of the reaction mixture after the transmetallation step shows only monomeric structures and a rac/meso ratio of 1. A mixture with a rac/meso ratio of 1 was isolated with a 7% yield due to its low stability.

### Example 8 (Comparative)

### Synthesis of 1,3-propandiylbis (2-methyl indacenyl) zirconium dichloride via classical synthesis

The preparation was carried out analogously as described in Example 1 (Comparative) with the exception that 1,3-bis(2-methyl indacenyl)propane was used instead of 1,3-bis(indenyl)propane. According to 1H-NMR, only oligomeric complexes and intractable material has been formed.

1. A process for the preparation of ansa metallocenes comprising bridges of a chain having a backbone of at least three carbon atoms, the process comprising:
deprotonating a biscyclopentadienyl ligand bridged by a chain having a backbone of at least three carbon atoms by a base; and
reacting the deprotonated ligand with at least one alkali or alkaline earth metal alkylating agent and a salt of a transition metal belonging to group 3, 4, 5, 6 or to the lanthanide or actinide groups of the Periodic Table of the Elements.

2. The process according to claim 1 comprising:
(1) deprotonating an alkylene biscyclopentadienyl ligand wherein the ligands are bridged by a chain having a backbone of at least three carbon atoms with 2 molar equivalents of a deprotonating base;
(2) adding 2 molar equivalents of an alkylating agent; and
(3) adding one molar equivalent of a salt of a transition metal belonging to group 4 of the Periodic Table of the Elements.

3. The process according to claim 1, wherein the process is carried out in an aprotic solvent.

4. The process according to claim 3, wherein the aprotic solvent is an aromatic or aliphatic hydrocarbon selected from the group consisting of benzene, toluene, pentane, hexane, heptane and cyclohexane, or is an ether selected from the group consisting of diethylether and tetrahydrofurane.

5. The process according to claim 1 wherein the ansa metallocene has the structure of formula I: 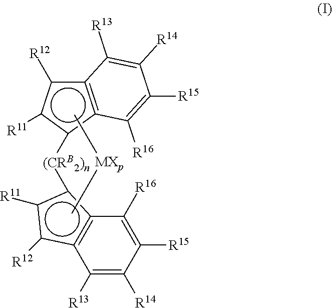
wherein
M is a transition metal belonging to group 3, 4, 5, 6 or to the lanthanide or actinide groups of the Periodic Table of the Elements (IUPAC version);
R^{B} may be the same or different and are selected from the group consisting of hydrogen, halogen, trimethylsilyl, C₁-C₁₀-alkyl, C₁-C₁₀-fluoroalkyl, C₆-C₁₀ fluoroaryl, C₆-C₁₀ aryl, C₁-C₁₀ alkoxy, C₇-C₁₅ alkylaryloxy, C₂-C₁₀ alkenyl, C₇-C₄₀ arylalkyl, C₈-C₄₀ arylalkenyl and C₇-C₄₀ alkylaryl;
n is an integer between 3 and 20;
X are the same or different and are selected from the group consisting of linear or branched, saturated or unsaturated C₁-C₂₀ alkyl, C₃-C₂₀ cycloalkyl, C₆-C₂₀ aryl, C₇-C₂₀ alkylaryl and C₇-C₂₀ arylalkyl groups, optionally containing one or more Si or Ge atoms;
p is an integer from 1 to 3, being equal to the oxidation state of the metal M minus 2;
R¹¹ and R¹² are identical or different and are each hydrogen or a C₁-C₂₀ group; and
R¹³, R¹⁴, R¹⁵ and R¹⁶ are identical or different and are each a hydrogen atom or a C₁-C₂₀ group,
and the alkylene biscyclopentadienyl ligand has the structure of formula (II):

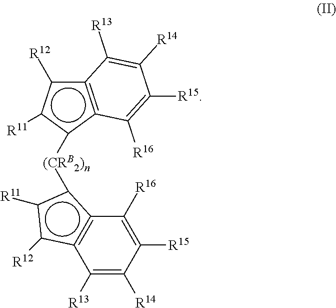

6. The process according to claim 1,
wherein
M is zirconium;
X are methyl groups;
R^{B} are hydrogen atoms;
n is 3;
R¹², R¹³ and R¹⁶ are the same and hydrogen;
R¹¹ is hydrogen or a C₁-C₈ alkyl and
R¹⁴ and R¹⁵ are the same or different and selected from hydrogen and C₁-C₈ alkyl, or R¹⁴ and R¹⁵ together with the two carbon atoms of the indenyl form an aromatic or aliphatic C₅ or C₆ ring.

7. The process according to claim 1 wherein the salt of the transition metal is used in the form of an ether complex prepared in a hydrocarbon solvent and used directly in the reaction with the ligand salt without separation from the solvent medium.

8. The process according to claim 7 wherein the ether complex of the transition metal salt is ZrCl₄.2 THF in toluene as the solvent.

9. The process according to claim 1, wherein the alkylating agent is methyllithium.

10. The process of claim 5 wherein R¹¹ and R¹² are a C₁-C₁₈-alkyl selected from methyl, ethyl, n-propyl, n-butyl, n-pentyl, n-hexyl, n-heptyl, n-octyl, n-nonyl, n-decyl, cyclopentyl or cyclohexyl, isopropyl, isobutyl, isopentyl, isohexyl, tert-butyl, C₂-C₁₀-alkenyl, C₃-C₁₅-alkylalkenyl, C₆-C₁₈-aryl, C₄-C₁₈-heteroaryl, C₇-C₂₀-arylalkyl, C₇-C₂₀-alkylaryl, fluorinated C₁-C₁₂-alkyl, fluorinated C₆-C₁₈-aryl, fluorinated C₇-C₂₀-arylalkyl or fluorinated C₇-C₂₀-alkylaryl, where R¹¹ together with R¹² may also form a monocyclic or polycyclic ring system.

11. The process of claim 5 wherein R¹³, R¹⁴, R¹⁵, and R¹⁶, are selected from methyl, ethyl, n-propyl, n-butyl, n-pentyl, n-hexyl, n-heptyl, n-octyl, n-nonyl, n-decyl, cyclopentyl or cyclohexyl, isopropyl, isobutyl, isopentyl, isohexyl, tert-butyl, C₂-C₁₀-alkenyl, C₃-C₁₅-alkylalkenyl, C₆-C₁₈-aryl, C₄-C₁₈-heteroaryl, C₇-C₂₀-arylalkyl, C₇-C₂₀-alkylaryl, fluorinated C₁-C₁₂-alkyl, fluorinated C₆-C₁₈-aryl, fluorinated C₇-C₂₀-arylalkyl or fluorinated C₇-C₂₀-alkylaryl and two adjacent radicals R¹³ and R¹⁴ or R¹⁴ and R¹⁵ or R¹⁵ and R¹⁶ may form together with the two carbon atoms of the indenyl ring a monocyclic or bi- or polycyclic ring system.

12. The process of claim 11 wherein the monocyclic or bi- or polycyclic ring system is selected from an aromatic or aliphatic cyclopentyl, cyclohexyl, cycloheptyl, cyclooctyl, cyclononyl or cyclodecyl.
